(19) United States
(12) Patent Application Publication
(10) Pub. No.: US 2025/0364593 A1
(43) Pub. Date: Nov. 27, 2025

(54) LITHIUM PRIMARY BATTERY AND PREPARATION METHOD THEREOF

(71) Applicant: EVE ENERGY CO., LTD., Huizhou (CN)

(72) Inventors: Linjie Chen, Huizhou (CN); Guiwei Chen, Huizhou (CN); Yajuan Ji, Huizhou (CN); Ruirui Zhao, Huizhou (CN)

(21) Appl. No.: 19/216,664

(22) Filed: May 22, 2025

(30) Foreign Application Priority Data
May 23, 2024 (CN) 202410652941.7
Aug. 5, 2024 (WO) PCT/CN2024/109788

(51) Int. Cl. H01M 10/0565; H01M 4/02; H01M 4/66; H01M 10/0525; H01M 10/0562

(52) U.S. Cl. CPC H01M 10/0565; H01M 10/0525; H01M 10/0562; H01M 2004/021; H01M 4/661; H01M 2300/0071; H01M 2300/0082

(57) ABSTRACT

Provided in the present disclosure is a lithium primary battery and a preparation method thereof. The lithium primary battery includes a positive electrode sheet and a negative electrode sheet, in which the positive electrode sheet includes a positive current collector, and both a positive active coating and an electrolyte layer sequentially provided on at least one surfaces of the positive current collector, the positive active coating includes a positive active material, a first polymer solid electrolyte, an oxide solid electrolyte, and a first lithium salt, and the electrolyte layer includes a second polymer solid electrolyte and a second lithium salt.

### CROSS REFERENCE TO RELEATED APPLICATIONS

The present disclosure claims the priority of Chinese Patent Application No. 202410652941.7 filed on May 23, 2024 before CNIPA, and PCT Application Serial No. PCT/CN2024/109788 filed on Aug. 5, 2024. All the above are hereby incorporated by reference in their entirety.

### TECHNICAL FIELD

The present disclosure relates to the technical field of batteries and, particularly, to a lithium primary battery and a preparation method thereof.

### BACKGROUND

The continuous depletion of fossil fuels and the resulting energy crisis and environmental problems caused by non-renewable energy sources are becoming increasingly serious. Efficient and stable energy conversion and storage devices are attracting much attention. Lithium batteries have the advantage of high energy density and have become the most widely used electrochemical energy storage devices, being used on a large scale in various fields. Lithium primary batteries have significant advantages such as good storage, stable discharge performance, and high energy density, and are widely used in military products, outdoor equipment and other fields.

### SUMMARY

As a first aspect, provided in the present disclosure is a lithium primary battery, including a positive electrode sheet and a negative electrode sheet, in which the positive electrode sheet includes a positive current collector, and both a positive active coating and an electrolyte layer sequentially provided on at least one surfaces of the positive current collector, the positive active coating includes a positive active material, a first polymer solid electrolyte, an oxide solid electrolyte, and a first lithium salt, the electrolyte layer includes a second polymer solid electrolyte and a second lithium salt; the first or second polymer solid electrolyte includes at least one of polyethylene oxide (PEO), polycarbonate (PPC), polyacrylonitrile (PAN), polysiloxane (PDMS), and polymethacrylate (PMMA); and the oxide solid electrolyte includes at least one of Li_{1.5}Al_{0.5}Ge_{1.5}(PO₄)₃ (LAGP), Li_{1.4}Al_{0.4}Ti_{1.6}(PO₄)₃ (LATP), Li_{0.33}La_{0.557}TiO₃ (LLTO), and Li₇La₃Zr₂O₁₂ (LLZO).

As a second aspect, provided in the present disclosure is a preparation method of a lithium primary battery, including the following. S1, a mixture is prepared by employing a polymer solid electrolyte, an oxide solid electrolyte, and a solvent. S2, a positive electrode slurry is prepared by employing a positive active material, a conductive agent, a binder, and a solvent. S3, the mixture, the positive electrode slurry, and a lithium salt well are mixed, and are coated on at least one surfaces of a positive current collector to form a positive active coating. S4, an electrolyte solution is prepared by employing a polymer solid electrolyte, a lithium salt, a plasticizer, and a solvent. S5, the electrolyte solution is applied to the surface of the positive active coating to form an electrolyte layer to prepare a positive electrode sheet. S6, the positive electrode sheet and a negative electrode sheet are assembled to prepare the lithium primary battery. The polymer solid electrolyte includes at least one of polyethylene oxide, polycarbonate, polyacrylonitrile, polysiloxane, polyvinylidene fluoride, and polymethacrylate. The oxide solid electrolyte includes at least one of Li_{1.5}Al_{0.5}Ge_{1.5}(PO₄)₃, Li_{1.4}Al_{0.4}Ti_{1.6}(PO₄)₃, Li_{0.33}La_{0.557}TiO₃, and Li₇La₃Zr₂O₁₂.

### BRIEF DESCRIPTION OF THE DRAWINGS

In order to explain technical solutions in implementations of the present disclosure more clearly, the following will give a brief introduction to the accompanying drawings required for describing the implementations. Apparently, the accompanying drawings in the following description illustrate some implementations of the present disclosure. For those of ordinary skill in the art, other accompanying drawings can be obtained according to these accompanying drawings without creative efforts.

FIG. 1 is a schematic structural diagram of a lithium primary battery according to implementations of the present disclosure.

FIG. 2 is a schematic flow diagram of a preparation method of a lithium primary battery according to implementations of the present disclosure.

### DETAILED DESCRIPTION

Traditional lithium primary batteries usually employ organic liquids as the electrolyte, but the flammability and corrosiveness of organic electrolytes greatly limits the practical application of lithium primary batteries. Moreover, the manufacturing process of lithium primary batteries is difficult due to the small size of the cells, and it is easy to overfill or underfill the cells with electrolyte, which ultimately leads to low consistency and production yield of the prepared lithium primary batteries and affects the service life and self-discharge of the lithium primary batteries.

To address the above problem, a lithium primary battery and a preparation method thereof are provided in the present disclosure.

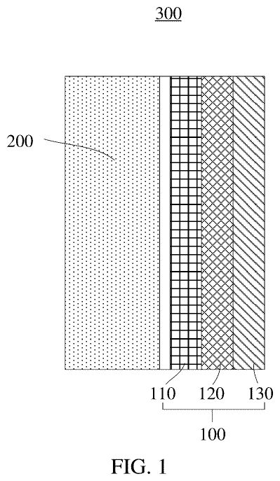

Referring to FIG. 1, the present disclosure provided a lithium primary battery 300. The lithium primary battery 300 includes a positive electrode sheet 100 and a negative electrode sheet 200. The positive electrode sheet 100 includes a positive current collector 110, and both a positive active coating 120 and an electrolyte layer 130 sequentially provided on at least one surfaces of the positive current collector 110. The positive active coating 120 includes a positive active material, a first polymer solid electrolyte, an oxide solid electrolyte, and a first lithium salt. The electrolyte layer 130 includes a second polymer solid electrolyte and a second lithium salt. The first or second polymer solid electrolyte includes at least one of polyethylene oxide, polycarbonate, polyacrylonitrile, polysiloxane, and polymethacrylate. The oxide solid electrolyte includes at least one of Li_{1.5}Al_{0.5}Ge_{1.5}(PO₄)₃, Li_{1.4}Al_{0.4}Ti_{1.6}(PO₄)₃, Li_{0.33}La_{0.557}TiO₃, and Li₇La₃Zr₂O₁₂.

In the present application, a polymer solid electrolyte and an oxide solid electrolyte are introduced into the positive active coating of the positive electrode sheet, and an electrolyte layer containing the polymer solid electrolyte is compounded on the surface of the positive active coating. Applying the aforementioned positive electrode sheet to a lithium primary battery, on the one hand, the lithium primary battery is a solid-state battery, eliminating the need for the liquid injection process, which improves the safety performance and energy density of the lithium primary battery while also effectively solving the difficulty of liquid injection during the preparation of traditional lithium primary batteries, and improving production efficiency. On the other hand, the positive active coating contains a first polymer solid electrolyte, an oxide solid electrolyte and a first lithium salt, and the electrolyte layer on the surface of the positive active coating contains a second polymer solid electrolyte; By simultaneously introducing the polymer solid electrolyte both in the positive active coating of the positive electrode sheet and in the electrolyte layer compounded on the surface of the positive active coating, the interface compatibility between the electrolyte layer and the electrode can be effectively improved, so that the electrolyte layer is in close contact with the electrode, which extends the service life of the lithium primary battery and reduces the self-discharge of the lithium primary battery.

In some implementations, a thickness of the positive active coating is 50 to 150 μm.

In some implementations, a thickness of the electrolyte layer is 6 to 30 μm.

In some implementations, the first or second polymer solid electrolyte is PEO, and the oxide solid electrolyte is LATP.

In some implementations, the positive active material includes at least one of manganese dioxide and CFₓ(0.5<x≤1).

In some implementations, the positive current collector is an aluminum foil coated with carbon.

Employing an aluminum foil coated with carbon as the positive current collector improves the conductivity and also improves the contact interface between the aluminum foil and the positive active coating, increasing the adhesion between the positive active coating and the aluminum foil, thereby increasing the energy density and extending the service life of the lithium primary batteries.

In some implementations, the positive active coating further includes a conductive agent and a binder; the conductive agent includes at least one of graphite, carbon nanotube, acetylene black, and conductive carbon black; and the binder includes at least one of polyvinylidene fluoride (PVDF) and polyvinylidene fluoride-hexafluoropropylene copolymer (PVDF-HFP).

In some implementations, in the positive active coating, calculated by a mass ratio, the first positive active material: the first polymer solid electrolyte: the oxide solid electrolyte: the first lithium salt=(75-85):(5-10):(1-5):(1-3).

In some implementations, the conductive agent is a mixture of carbon nanotube and graphite in a mass ratio of (1-3):(1-2).

In some implementations, the negative electrode sheet is a lithium metal foil, and a thickness of the lithium metal foil is 30 to 80 μm.

In some implementations, the electrolyte layer further includes a plasticizer, and the plasticizer includes at least one of amber nitrile, acetonitrile, and polyethylene glycol dimethyl ether; and in the electrolyte layer, calculated by a mass ratio, the second polymer solid electrolyte: the plasticizer: the second lithium salt=(40-80):(5-10):(20-60).

The introduction of the plasticizer into the electrolyte layer may further lead to an increase in the ionic conductivity of the electrolyte layer.

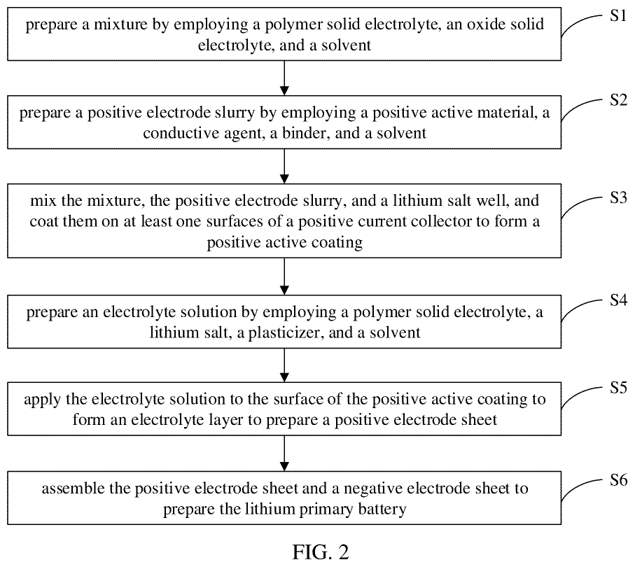

Referring to FIG. 2, the present disclosure provided a preparation method of a lithium primary battery. The preparation method includes the following. S1, a mixture is prepared by employing a polymer solid electrolyte, an oxide solid electrolyte, and a solvent. S2, a positive electrode slurry is prepared by employing a positive active material, a conductive agent, a binder, and a solvent. S3, the mixture, the positive electrode slurry, and a lithium salt well are mixed, and are coated on at least one surfaces of a positive current collector to form a positive active coating. S4, an electrolyte solution is prepared by employing a polymer solid electrolyte, a lithium salt, a plasticizer, and a solvent. S5, the electrolyte solution is applied to the surface of the positive active coating to form an electrolyte layer to prepare a positive electrode sheet. S6, the positive electrode sheet and a negative electrode sheet are assembled to prepare the lithium primary battery. The polymer solid electrolyte includes at least one of polyethylene oxide, polycarbonate, polyacrylonitrile, polysiloxane, polyvinylidene fluoride, and polymethacrylate. The oxide solid electrolyte includes at least one of Li_{1.5}Al_{0.5}Ge_{1.5}(PO₄)₃, Li_{1.4}Al_{0.4}Ti_{1.6}(PO₄)₃, Li_{0.33}La_{0.557}TiO₃, and Li₇La₃Zr₂O₁₂.

In the preparation method of the lithium primary battery involved in the present application, the positive electrode slurry containing the polymer solid electrolyte and the oxide solid electrolyte is coated on the surface of the positive current collector to form a positive active coating, and then the electrolyte solution containing the polymer solid electrolyte is coated on the surface of the positive active coating to form an electrolyte layer. The prepared positive electrode sheet is assembled with the negative electrode sheet. The electrolyte layer is closely bonded to the positive active coating in the positive electrode sheet and the negative electrode sheet, which extends the service life of the lithium primary battery and reduces the self-discharge of the lithium primary battery. Furthermore, the liquid injection process is omitted in the preparation process of the aforementioned lithium primary battery, effectively addressing the difficulty of liquid injection in the preparation process of traditional lithium primary batteries and improving production efficiency.

In some implementations, in S1, a solid content of the mixture is 10% to 30%.

In some implementations, the solvent includes at least one of N-methylpyrrolidone (NMP), dimethyl sulfoxide (DMSO), dimethylformamide (DMF), anisole, and p-xylene.

In some implementations, the lithium salt includes at least one of lithium hexafluorophosphate (LiPF₆), lithium tetrafluoroborate (LiBF₄), lithium perchlorate (LiClO₄), lithium hexafluoroarsenate (AsF₆Li), lithium bis(difluorosulfonyl)imide (LiFSI), lithium bis(trifluoromethylsulfonyl)imide (LiTFSI), lithium difluoro (oxalato) borate (LiODFB), and lithium bis(oxalate) borate (LiBOB).

In some implementations, in the positive active coating, calculated by a mass ratio, the positive active material: the conductive agent: the binder: the first polymer solid electrolyte: the oxide solid electrolyte: the first lithium salt=(75-85):(3-4):(2-3):(5-10):(1-5):(1-3).

### Example 1

A lithium primary battery was prepared by the following steps:

S1. Under the conditions of a temperature of 25±5° C. and a humidity of 65±5%, the polymer solid electrolyte PEO, the oxide solid electrolyte LATP and the solvent NMP were each dehydrated in advance until the water content of each component was ≤20 ppm, then mixed well to prepare a mixture with a solid content of 20%.

S2. Under the conditions of a temperature of 25±5° C. and a humidity of 65±5%, the positive active material manganese dioxide, the conductive agent, the binder PVDF and the solvent NMP were each dehydrated in advance until the water content of each component is ≤20 ppm; the binder PVDF was mixed with the solvent NMP to form a binder solution with a solid content of 7%; the positive electrode active material manganese dioxide and the conductive agent were then dissolved in the binder solution and mixed well to form a positive electrode slurry; and
the conductive agent is a mixture of carbon nanotube and graphite in a mass ratio of 1:1.

S3. The above mixture was mixed well with the above positive electrode slurry, and then lithium salt LiTFSI was added; after stirring, the mixture was coated on both surfaces of the aluminum foil coated with carbon on the positive current collector and dried at a temperature of 90±5° C. for 24=2 hours to form a positive active coating with a thickness of 100 μm on each surface; and
in steps S1, S2, and S3, calculated by a mass ratio, the positive active material: the conductive agent: the binder: the polymer solid electrolyte: the oxide solid electrolyte: the lithium salt=80:3.5:2.5:8:3:2.

S4. Under conditions of a dew point temperature of 25±5° C. and humidity of 65±5%, the polymer solid electrolyte PEO, lithium salt LiTFSI, plasticizer acetonitrile, and solvent NMP were dehydrated in advance until the water content of each component ≤20 ppm, the polymer solid electrolyte PEO, lithium salt LiTFSI and plasticizer acetonitrile were thoroughly mixed, and then added to the solvent NMP; the mixture was thoroughly mixed to prepare an electrolyte solution,
in which, calculated by a mass ratio, the polymer solid electrolyte: the plasticizer: the lithium salt=60:8:30.

S5. The electrolyte solution was coated on the surface of the positive active coating and dried at a temperature of 90±5° C. for 24±2 hours to form an electrolyte layer with a thickness of 15 μm to prepare a positive electrode sheet.

S6. The aforementioned positive electrode sheet was cut and assembled with the lithium metal negative electrode sheet to form a lithium primary battery, with the electrolyte layer in close contact with the negative electrode sheet.

### Example 2

A lithium primary battery was prepared by the following steps:

S1. Under the conditions of a temperature of 25±5° C. and a humidity of 65±5%, the polymer solid electrolyte PEO, the oxide solid electrolyte LATP and the solvent NMP were each dehydrated in advance until the water content of each component was ≤20 ppm, then mixed well to prepare a mixture with a solid content of 10%;

S2. Under the conditions of a temperature of 25±5° C. and a humidity of 65±5%, the positive active material manganese dioxide, the conductive agent, the binder PVDF and the solvent NMP were each dehydrated in advance until the water content of each component is ≤20 ppm; the binder PVDF was mixed with the solvent NMP to form a binder solution with a solid content of 7% to 10%; the positive electrode active material manganese dioxide and the conductive agent were then dissolved in the binder solution and mixed well to form a positive electrode slurry; and
the conductive agent is a mixture of carbon nanotube and graphite in a mass ratio of 1:2.

S3. The above mixture was mixed well with the above positive electrode slurry, and then lithium salt LiTFSI was added; after stirring, the mixture was coated on both surfaces of the aluminum foil coated with carbon on the positive current collector and dried at a temperature of 90±5° C. for 24±2 hours to form a positive active coating with a thickness of 150 μm on each surface; and
in steps S1, S2, and S3, calculated by a mass ratio, the positive active material: the conductive agent: the binder: the polymer solid electrolyte: the oxide solid electrolyte: the lithium salt=75:3:3:10:1:1.

S4. Under conditions of a dew point temperature of 25±5° C. and humidity of 65±5%, the polymer solid electrolyte PEO, lithium salt LiTFSI, plasticizer acetonitrile, and solvent NMP were dehydrated in advance until the water content of each component ≤20 ppm, the polymer solid electrolyte PEO, lithium salt LiTFSI and plasticizer acetonitrile were thoroughly mixed, and then added to the solvent NMP; the mixture was thoroughly mixed to prepare an electrolyte solution,
in which, calculated by a mass ratio, the polymer solid electrolyte: the plasticizer: the lithium salt=40:5:20.

S5. The electrolyte solution was coated on the surface of the positive active coating and dried at a temperature of 90±5° C. for 24±2 hours to form an electrolyte layer with a thickness of 6 μm to prepare a positive electrode sheet.

S6. The aforementioned positive electrode sheet was cut and assembled with the lithium metal negative electrode sheet to form a lithium primary battery, with the electrolyte layer in close contact with the negative electrode sheet.

### Example 3

A lithium primary battery was prepared by the following steps:

S1. Under the conditions of a temperature of 25±5° C. and a humidity of 65±5%, the polymer solid electrolyte PEO, the oxide solid electrolyte LATP and the solvent NMP were each dehydrated in advance until the water content of each component was ≤20 ppm, then mixed well to prepare a mixture with a solid content of 30%;

S2. Under the conditions of a temperature of 25±5° C. and a humidity of 65±5%, the positive active material manganese dioxide, the conductive agent, the binder PVDF and the solvent NMP were each dehydrated in advance until the water content of each component is ≤20 ppm; the binder PVDF was mixed with the solvent NMP to form a binder solution with a solid content of 7 to 10%; the positive electrode active material manganese dioxide and the conductive agent were then dissolved in the binder solution and mixed well to form a positive electrode slurry; and
the conductive agent is a mixture of carbon nanotube and graphite in a mass ratio of 3:1.

S3. The above mixture was mixed well with the above positive electrode slurry, and then lithium salt LiTFSI was added; after stirring, the mixture was coated on both surfaces of the aluminum foil coated with carbon on the positive current collector and dried at a temperature of 90±5° C. for 24±2 hours to form a positive active coating with a thickness of 50 μm on each surface; and
in steps S1, S2, and S3, calculated by a mass ratio, the positive active material: the conductive agent: the binder: the polymer solid electrolyte: the oxide solid electrolyte: the lithium salt=85:4:2:5:5:3.

S4. Under conditions of a dew point temperature of 25±5° C. and humidity of 65±5%, the polymer solid electrolyte PEO, lithium salt LiTFSI, plasticizer acetonitrile, and solvent NMP were dehydrated in advance until the water content of each component ≤20 ppm, the polymer solid electrolyte PEO, lithium salt LiTFSI and plasticizer acetonitrile were thoroughly mixed, and then added to the solvent NMP; the mixture was thoroughly mixed to prepare an electrolyte solution,
in which, calculated by a mass ratio, the polymer solid electrolyte: the plasticizer: the lithium salt=80:10:60.

S5. The electrolyte solution was coated on the surface of the positive active coating and dried at a temperature of 90±5° C. for 24±2 hours to form an electrolyte layer with a thickness of 30 μm to prepare a positive electrode sheet.

S6. The aforementioned positive electrode sheet was cut and assembled with the lithium metal negative electrode sheet to form a lithium primary battery, with the electrolyte layer in close contact with the negative electrode sheet.

### Example 4

The lithium primary battery provided in the present example differs from that in example 1 in that, in the preparation steps S1 and S4 of the lithium primary battery, an equal amount of polymer solid electrolyte PPC was employed to replace the polymer solid electrolyte PEO. Except for the above differences, the materials, formula ratios, and preparation operations employed in the present example were strictly the same as those in Example 1.

### Example 5

The lithium primary battery provided in the present example differs from that in example 1 in that, in the preparation steps S1 and S4 of the lithium primary battery, an equal amount of polymer solid electrolyte PAN was employed to replace the polymer solid electrolyte PEO. Except for the above differences, the materials, formula ratios, and preparation operations employed in the present example were strictly the same as those in Example 1.

### Example 6

The lithium primary battery provided in the present example differs from that in example 1 in that, in the preparation steps S1 and S4 of the lithium primary battery, an equal amount of polymer solid electrolyte PDMS was employed to replace the polymer solid electrolyte PEO. Except for the above differences, the materials, formula ratios, and preparation operations employed in the present example were strictly the same as those in Example 1.

### Example 7

The lithium primary battery provided in the present example differs from that in example 1 in that, in the preparation step S4 of the lithium primary battery, an equal amount of polymer solid electrolyte PVDF was employed to replace the polymer solid electrolyte PEO. Except for the above differences, the materials, formula ratios, and preparation operations employed in the present example were strictly the same as those in Example 1.

### Example 8

The lithium primary battery provided in the present example differs from that in example 1 in that, in the preparation steps S1 and S4 of the lithium primary battery, an equal amount of polymer solid electrolyte PMMA was employed to replace the polymer solid electrolyte PEO. Except for the above differences, the materials, formula ratios, and preparation operations employed in the present example were strictly the same as those in Example 1.

### Example 9

The lithium primary battery provided in the present example differs from that in example 1 in that, in the preparation steps S1 and S4 of the lithium primary battery, an equal amount of oxide solid electrolyte LAGP was employed to replace the oxide solid electrolyte LATP. Except for the above differences, the materials, formula ratios, and preparation operations employed in the present example were strictly the same as those in Example 1.

### Example 10

The lithium primary battery provided in the present example differs from that in example 1 in that, in the preparation step S1 of the lithium primary battery, an equal amount of oxide solid electrolyte LLTO was employed to replace the oxide solid electrolyte LATP. Except for the above differences, the materials, formula ratios, and preparation operations employed in the present example were strictly the same as those in Example 1.

### Example 11

The lithium primary battery provided in the present example differs from that in example 1 in that, in the preparation step S1 of the lithium primary battery, an equal amount of oxide solid electrolyte LLZO was employed to replace the oxide solid electrolyte LATP. Except for the above differences, the materials, formula ratios, and preparation operations employed in the present example were strictly the same as those in Example 1.

### Example 12

The lithium primary battery provided in the present example differs from that in example 1 in that: (1) in the preparation step S3 of the lithium primary battery, the thickness of the prepared positive active coating was 40 μm; (2) in the preparation step S5 of the lithium primary battery, the thickness of the prepared electrolyte layer was 3 μm. Except for the above differences, the materials, formula ratios, and preparation operations employed in the present example were strictly the same as those in Example 1.

### Example 13

The lithium primary battery provided in the present example differs from that in example 1 in that: (1) in the preparation step S3 of the lithium primary battery, the thickness of the prepared positive active coating was 180 μm; (2) in the preparation step S5 of the lithium primary battery, the thickness of the prepared electrolyte layer was 40 μm. Except for the above differences, the materials, formula ratios, and preparation operations employed in the present example were strictly the same as those in Example 1.

### Example 14

The lithium primary battery provided in the present example differs from that in example 1 in that, in the preparation step S3 of the lithium primary battery, the positive current collector employed an aluminum foil without a carbon coating instead of an aluminum foil coated with carbon. Except for the above differences, the materials, formula ratios, and preparation operations employed in the present example were strictly the same as those in Example 1.

### Example 15

The lithium primary battery provided in the present example differs from that in example 1 in that, in the preparation step S4 of the lithium primary battery, an equal amount of lithium salt was employed to replace the plasticizer. Except for the above differences, the materials, formula ratios, and preparation operations employed in the present example were strictly the same as those in Example 1.

### Example 16

The lithium primary battery provided in the present example differs from that in example 1 in that, in the preparation step S2 of the lithium primary battery, an equal amount of positive active material CFₓ(0.5<x≤1) was employed to replace the positive active material manganese dioxide. Except for the above differences, the materials, formula ratios, and preparation operations employed in the present example were strictly the same as those in Example 1.

### Comparative Example 1

The lithium primary battery provided in the present comparative example differs from that in example 1 in that, in the preparation step S1 of the lithium primary battery, an equal amount of polymer solid electrolyte PEO was employed to replace the oxide solid electrolyte LATP. Except for the above differences, the materials, formula ratios, and preparation operations employed in the present comparative example were strictly the same as those in Example 1.

### Comparative Example 2

The lithium primary battery provided in the present comparative example differs from that in example 1 in that, in the preparation step S1 of the lithium primary battery, an equal amount of oxide solid electrolyte LATP was employed to replace the polymer solid electrolyte PEO. Except for the above differences, the materials, formula ratios, and preparation operations employed in the present comparative example were strictly the same as those in Example 1.

### Comparative Example 3

The lithium primary battery provided in the present comparative example differs from that in example 1 in that: (1) in the preparation step S1 of the lithium primary battery, an equal amount of polymer solid electrolyte PEO was employed to replace the oxide solid electrolyte LATP; (2) in the preparation step S3 of the lithium primary battery, the preparation process of the positive active coating did not contain the lithium salt LiTFSI. Except for the above differences, the materials, formula ratios, and preparation operations employed in the present comparative example were strictly the same as those in Example 1.

### Test Example

### 1. Test Objects

The lithium primary batteries prepared by examples 1 to 16 and comparative examples 1 to 3 were subjected to the relevant performance tests in the present test example.

### 2. Test Items

The self-discharge of the battery is an important parameter for evaluating the performance of a lithium primary battery. The static measurement method was employed in the present test example to measure the self-discharge of the lithium primary battery: Under certain environmental conditions (85° C., 85% of humidity), the self-discharge of a lithium primary battery was evaluated by measuring the change in open-circuit voltage before and after the battery was left to stand for a long period of time.

The annual self-discharge rate of lithium primary batteries was calculated according to the following formula: The open-circuit voltage of a lithium primary battery is measured when it is at full charge before being left to stand, and is denoted by V₀. The open-circuit voltage of the lithium primary battery is measured after it has been left to stand for 30 days under conditions of 85° C. and 85% humidity, and is denoted by V₁. The self-discharge rate of the lithium primary battery after 30 days of storage η=[(V₀−V₁)/V₀]×100%, and the annual self-discharge rate is calculated or converted based on the self-discharge rate of the lithium primary battery after 30 days of storage.

### 3. Test Results

TABLE 1
Test results for annual self-discharge
rates of lithium primary batteries

| Groups | Annual self-discharge rates η (%) |
|---|---|
| Example 1 | 2.0 |
| Example 2 | 2.1 |
| Example 3 | 2.5 |
| Example 4 | 3.2 |
| Example 5 | 3.5 |
| Example 6 | 3.6 |
| Example 7 | 3.8 |
| Example 8 | 3.1 |
| Example 9 | 3.3 |
| Example 10 | 3.6 |
| Example 11 | 3.4 |
| Example 12 | 4.1 |
| Example 13 | 3.9 |
| Example 14 | 2.9 |
| Example 15 | 4.2 |
| Example 16 | 2.8 |
| Comparative Example 1 | 4.6 |
| Comparative Example 2 | 4.5 |
| Comparative Example 3 | 4.8 |

The relevant performance test results of the lithium primary batteries provided in examples 1 to 16 and comparative examples 1 to 3 are shown in Table 1.

The positive active coating of the positive electrode sheet of the lithium primary battery provided in examples 1 to 3 employed manganese dioxide as the positive active material and the polymeric solid electrolyte PEO, the oxide solid electrolyte LATP and the lithium salt LiTFSI were introduced, with the surface of the positive active coating being coated with an electrolyte layer containing the polymer solid electrolyte PEO and the lithium salt LiTFSI. The test results show that the annual self-discharge rates of the lithium primary batteries provided in examples 1 to 3 were only 2.0 to 2.5%. Therefore, the relatively low annual self-discharge rates may extend the service life of the lithium primary batteries.

Compared with example 1, the positive active coating of the positive electrode sheet of the lithium primary battery provided in comparative example 1 did not contain the oxide solid electrolyte LATP, the positive active coating of the positive electrode sheet of the lithium primary battery provided in comparative example 2 did not contain the polymer solid electrolyte PEO, and the positive active coating of the positive electrode sheet of the lithium primary battery provided in comparative example 3 did not contain the oxide solid electrolyte LATP and the electrolyte layer did not contain lithium salt. The test results show that the annual self-discharge rates of the lithium primary batteries provided in comparative examples 1, 2, and 3 were significantly higher than that in example 1.

Compared with example 1, the polymer solid electrolytes employed in the positive active coating of the positive electrode sheet and the electrolyte layer of the lithium primary battery provided in examples 4, 5, 6 and 8 are PPC, PAN, PDMS and PMMA, respectively, the polymer solid electrolyte employed in the electrolyte layer of the positive electrode sheet of the lithium primary battery provided in example 7 is PVDF, and the oxide solid electrolytes employed in the positive active coating of the positive electrode sheet of the lithium primary battery provided in examples 9, 10, and 11 are LAGP, LLTO, and LLZO, respectively. The test results show that the annual self-discharge rates of the lithium primary batteries provided in examples 4, 5, 6, 7, 8, 9, 10, and 11 were all higher than that in example 1.

Compared with example 1, in the lithium primary battery provided in example 12, the thickness of the positive active coating was <50 μm and the thickness of the electrolyte layer of the positive electrode sheet was <6 μm, and, in the lithium primary battery provided in example 13, the thickness of the positive active coating was >150 μm and the thickness of the electrolyte layer of the positive electrode sheet was >30 μm. The test results show that the annual self-discharge rates of the lithium primary batteries provided in examples 12 and 13 were higher than that in example 1.

Compared with example 1, the positive current collector employed in the positive electrode sheet of the lithium primary battery provided in Example 14 is an aluminum foil without a carbon coating, the positive active material employed in the positive electrode sheet of the lithium primary battery provided in example 16 was CFₓ(0.5<x≤1). The test results show that the annual self-discharge rates of the lithium primary batteries provided in examples 14 and 16 were slightly higher than that in example 1. The electrolyte layer of the positive electrode of the lithium primary battery provided in example 15 did not contain a plasticizer. The test results show that the annual self-discharge rates of the lithium primary batteries provided in example 15 was significantly higher than that in example 1.

1. A lithium primary battery, comprising a positive electrode sheet and a negative electrode sheet, wherein the positive electrode sheet comprises a positive current collector, and both a positive active coating and an electrolyte layer sequentially provided on at least one surfaces of the positive current collector, the positive active coating comprises a positive active material, a first polymer solid electrolyte, an oxide solid electrolyte, and a first lithium salt, the electrolyte layer comprises a second polymer solid electrolyte and a second lithium salt; the first or second polymer solid electrolyte comprises at least one of polyethylene oxide, polycarbonate, polyacrylonitrile, polysiloxane, and polymethacrylate; and the oxide solid electrolyte comprises at least one of Li_{1.5}Al_{0.5}Ge_{1.5}(PO₄)₃, Li_{1.4}Al_{0.4}Ti_{1.6}(PO₄)₃, Li_{0.33}La_{0.557}TiO₃, and Li₇La₃Zr₂O₁₂.

2. The lithium primary battery according to claim 1, wherein a thickness of the positive active coating is 50 to 150 μm, and/or, a thickness of the electrolyte layer is 6 to 30 μm.

3. The lithium primary battery according to claim 1, wherein the first or second polymer solid electrolyte is polyethylene oxide, and the oxide solid electrolyte is Li_{1.4}Al_{0.4}Ti_{1.6}(PO₄)₃.

4. The lithium primary battery according to claim 1, wherein the positive active material comprises at least one of manganese dioxide and CFₓ(0.5<x≤1).

5. The lithium primary battery according to claim 1, wherein the positive current collector is an aluminum foil coated with carbon.

6. The lithium primary battery according to claim 1, wherein: in the positive active coating, calculated by a mass ratio, the first positive active material: the first polymer solid electrolyte:
the oxide solid electrolyte: the first lithium salt=(75-85):(5-10):(1-5):(1-3).

7. The lithium primary battery according to claim 1, wherein the negative electrode sheet is a lithium metal sheet.

8. The lithium primary battery according to claim 1, wherein the electrolyte layer further comprises a plasticizer, and the plasticizer comprises at least one of amber nitrile, acetonitrile, and polyethylene glycol dimethyl ether; and
in the electrolyte layer, calculated by a mass ratio, the second polymer solid electrolyte: the plasticizer: the second lithium salt=(40-80):(5-10):(20-60).

9. A preparation method of a lithium primary battery, comprising following steps:
S1. preparing a mixture by employing a polymer solid electrolyte, an oxide solid electrolyte, and a solvent;
S2. preparing a positive electrode slurry by employing a positive active material, a conductive agent, a binder, and a solvent;
S3. mixing the mixture, the positive electrode slurry, and a lithium salt well, and coating them on at least one surfaces of a positive current collector to form a positive active coating;
S4. preparing an electrolyte solution by employing a polymer solid electrolyte, a lithium salt, a plasticizer, and a solvent;
S5. applying the electrolyte solution to the surface of the positive active coating to form an electrolyte layer to prepare a positive electrode sheet;
S6. assembling the positive electrode sheet and a negative electrode sheet to prepare the lithium primary battery;
the polymer solid electrolyte comprises at least one of polyethylene oxide, polycarbonate, polyacrylonitrile, polysiloxane, polyvinylidene fluoride, and polymethacrylate; and
the oxide solid electrolyte comprises at least one of Li_{1.5}Al_{0.5}Ge_{1.5}(PO₄)₃, Li_{1.4}Al_{0.4}Ti_{1.6}(PO₄)₃, Li_{0.33}La_{0.557}TiO₃, and Li₇La₃Zr₂O₁₂.

10. The preparation method of the lithium primary battery according to claim 9, wherein, in S1, a solid content of the mixture is 10% to 30%.
